(19) United States
(12) Patent Application Publication
(10) Pub. No.: US 2006/0028001 A1
(43) Pub. Date: Feb. 9, 2006

(54) Assembly having steering wheel and gasbag module

(75) Inventors: Andreas Heil, Aschaffenburg (DE); Michael Schneider, Sulzbach (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 11/191,570

(22) Filed: Jul. 28, 2005

(30) Foreign Application Priority Data
Aug. 3, 2004 (DE) 10 2004 037 462.7

(51) Int. Cl. B60R 21/16

(52) U.S. Cl. 280/731

(57) ABSTRACT

An assembly having a steering wheel (10) and a gasbag module (16) that is connected to the steering wheel (10) includes a generator support (20) formed of plastic for attaching a gas generator (34). The generator support (20) in a predetermined area is reinforced by a metal layer that is produced by electroplating to a layer thickness sufficient to increase the strength of the generator support (20) and the metal layer constitutes at least one electrically conductive contact element (28).

### TECHNICAL FIELD

The present invention relates to an assembly having a steering wheel and a gasbag module that is connected to the steering wheel, the gasbag module including a support part formed of plastic for attaching a gas generator.

### BACKGROUND OF THE INVENTION

Gasbag modules are a component part of vehicle occupant restraint systems and can be arranged, for example, in the steering wheel to protect the driver. However, in this context, problems arise with respect to the spatial arrangement of the contacts for activating a horn signal, because a separate activation lever is often hard to reach for the driver and in critical situations cannot be located. According to the so-called “floating horn” principle, gasbag modules are therefore arranged on the steering wheel such that the horn signal can be activated by pressure that is exerted by the driver on the gasbag module. In this context, one contact is arranged on the gasbag module and one contact on the steering wheel, and the gasbag module is connected to the steering wheel by elastic spacers. In this way, the contacts can be closed when a pressure is exerted on the gas bag module from a motion of the gasbag module in the direction of the steering wheel, and in this way the horn or another electrical function element can be activated.

From DE 199 27 032 A1, an assembly is known that operates in accordance with this principle and that has a steering wheel and a gasbag module. The gasbag module includes a plastic generator support, which is manufactured in an injection molding process and into which a wire element is injected. The wire element has hoop-shaped segments, which are provided with plastic sleeves for electrical insulation and which engage in latching hooks that are arranged on the steering wheel for the purpose of attaching the gasbag module. The generator support also has one or more recesses, in which the wire element is accessible and is not electrically insulated. In these recesses, the wire element constitutes a contact that activates the horn and that cooperates with an electrically conductive opposite contact on the steering wheel. When the contact and the opposite contact are closed through pressure being exerted on the gasbag module in the direction of the steering wheel, the electrical horn is activated.

### SUMMARY OF THE INVENTION

It is an object of the present invention to provide a simply designed and mechanically sturdy assembly having a steering wheel and a gasbag module that is connected to the steering wheel, the gasbag module including a generator support formed of plastic for attaching a gas generator. According to the present invention, the generator support in a predetermined area is reinforced by a metal layer that is produced by electroplating to a layer thickness effective to increase the strength of the generator support, the metal layer constituting at least one electrically conductive contact element.

The present invention therefore combines in one component the functions of an electrical contact with a mechanical reinforcement of the plastic generator support. In this way, it is possible to manufacture the generator support so as to have a reduced wall thickness and at the same time to assure the mechanical load-carrying capacity even at boundary conditions at high or low temperatures. In addition, the gas generator can be manufactured with a less complex geometry, because the metal layers perform the task of electrical leads and therefore no additional components need to be integrated. Furthermore, the metal coating improves the heat resistance and mechanical characteristics of the generator support. Finally, the use of metal-coated plastics also results in savings of weight.

It is especially preferred if the electrically conductive contact element formed from the metal layer is a part of a conducting track that is arranged on the generator support. In this way, the opposite contacts on the steering wheel can also be configured variably. These opposite contacts can be a fixed contact element, e.g., a contact rivet, or a spring contact. The electrical contact element preferably functions to activate an electrical horn, in that it cooperates with the opposite contact on the steering wheel in accordance with the so-called “floating horn” principle.

In addition, it is preferable that the generator support comprises a latching element, by which the generator support is fixed in position on the steering wheel. The latching element can specifically include a plastic latching hook that is formed integrally with the generator support, the latching hook snapping into a corresponding recess in the steering wheel or the steering wheel skeleton. According to the present invention, the latching hook is also reinforced by a metal layer that is formed by electroplating. The metal layer on the latching hook and the metal layer forming the electrical contact element can be applied in one method step. They can constitute a functional unit, but they are preferably kept electrically insulated from each other. Finally, the gas generator can also have an exterior housing made of plastic, which, for increasing the strength of the housing, can be reinforced at least partially by a metal layer that is formed by electroplating. The electrically conductive metal layer can function particularly advantageously as a ground contact.

Reinforcing metal layers can be flexibly applied to plastics through electroplating, and the process can be used in a simple manner for forming separate metal layers that are electrically insulated from each other in any shape and at any locations on the generator support or other plastic parts of the gasbag module. Therefore, the subject matter of the present invention is also a method to manufacture an assembly having a steering wheel and a gasbag module connected to the steering wheel, the surface of the plastic generator support being pretreated in a predetermined area for generating a surface roughness, and metal being then deposited by electrolysis on the pretreated area to form an adherently bonded metal layer in a layer thickness effective to increase the strength of the generator support.

The thickness of the metal layers applied to the generator support or to the plastic housing of the gas generator is determined by the mechanical stresses to be expected on the specific components, and it can be adjusted in wide ranges through method parameters of the electrolytic deposition process such as the duration of the electroplating, the strength of the current, and the concentration of the electrolyte. The metal layers are preferably between 100 μm and about 2 mm thick. In layer thicknesses less than 100 μm, no improvement of the strength of the generator support is to be expected. Layer thicknesses of more than about 2 mm may be too expensive. The electrically conductive metal layer can be applied to any plastic. Thermoplastic plastics are preferred, specifically fiberglass-reinforced or carbon-fiber-reinforced thermoplastics, due to their good strength properties.

The pretreating of the plastic surface preferably includes a chemical etching and/or a plasma etching, so that undercuts are produced for the mechanical cramping of the metal layer on the plastic surface. Then, the pretreated plastic surface in the areas designated for coating is activated, for example using colloidal palladium, and, for generating sufficient electrical conductivity, is provided with a metal layer that is deposited by electroless plating. The layer thickness of the metal layer that is deposited by electroless plating can be up to 10 μm. The metal layer that is generated in this way is then reinforced by an electroplating process using a suitable electrolyte, to arrive at the final layer thickness.

### BRIEF DESCRIPTION OF THE DRAWINGS

FIG. 1 depicts a partial sectional view of the assembly according to the present invention;

FIG. 2 depicts a top view of the lower side of a generator support from the assembly according to FIG. 1; and

FIG. 3 depicts a schematic sectional view of the generator support from FIG. 2.

### DETAILED DESCRIPTION OF PREFERRED EMBODIMENTS

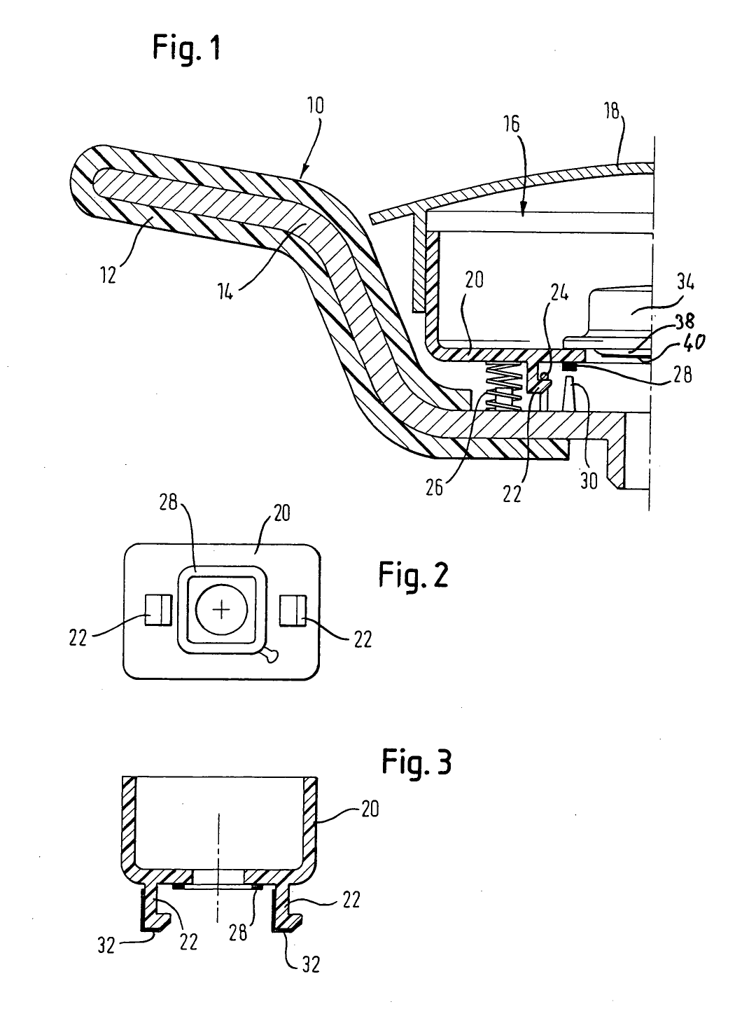

In FIG. 1, a steering wheel 10 is depicted, having an exterior covering 12 made of plastic and a steering wheel skeleton 14 made of metal. On a central section of steering wheel skeleton 14, a gasbag module 16 is arranged. Gas bag module 16 includes a driver-side cover 18 and a generator support 20 that is arranged on the steering wheel side and that in a familiar manner is connected in the area of a side wall to cover 18. On the base of generator support 20, which is made of plastic, specifically a fiberglass-reinforced or carbon-fiber-reinforced thermoplastic, one or more latching hooks 22 are integrally formed, which snap into a corresponding support 24 on the steering wheel skeleton and thus fix generator support 20 and gasbag module 16 in position on the steering wheel skeleton.

In addition, between the base of generator support 20 and steering wheel skeleton 14, one or more elastic spacers 26 are arranged, for example, a spiral spring, which adjust the distance between steering wheel skeleton 14 and the base of generator support 20. In addition, on the base of generator support 20, an electrical contact element 28 is provided, which cooperates with an opposite contact 30, for example a contact rivet, that is facing the contact element 28 and is arranged on steering wheel skeleton 14.

In the idle position, spacer 26 presses latching hook 22 against support 24, so that electrical contact element 28 is maintained at a defined distance from opposite contact 30. As a result of a pressure on cover 18 in the direction of the steering wheel, spacer 26 is compressed and a circuit is closed between electrical contact element 28 and opposite contact 30. In this way, an electrical function element, for example, an electrical horn, can be activated.

Electrical contact element 28 on the base of generator support 20 is applied through electroplating. In the embodiment depicted in FIG. 2, by way of example, electrical contact element 28 is shown as part of a printed circuit that is made up of a plurality of conducting tracks. In this manner, opposite contacts 30 can be variably placed on steering wheel skeleton 14. The layer thickness of electrical contact element 28 and of the conducting tracks is up to roughly 2 mm and is dimensioned such that the strength of thin-walled generator support 20 is sufficient for the stresses that arise under the conditions of use.

FIG. 3 shows that latching hooks 22 can also be reinforced by a metal layer 32 that is deposited through electroplating. Metal layer 32 and electrical contact element 28 in this embodiment are electrically insulated from each other. The layer thickness of the metal that is deposited onto latching hooks 22 is also up to about 2 mm.

Finally, gas generator 34, which is schematically depicted in FIG. 1, can have an external housing 38 made of plastic, which at least in some areas can be reinforced by a metal layer 40 that is deposited by electroplating at a thickness of up to 2 mm, the metal layer 40 increasing the strength of the plastic housing and at the same time being able to perform the function of an electrical lead or a ground contact.

To produce electrical contact element 28 on the base of generator support 20, and, if appropriate, to deposit metal layer 32 onto latching hooks 22 and metal layer 40 on gas generator housing 38, the plastic surface of generator support 20 or housing 38 is pretreated with a chemical etching in the areas in which the electroplating is to be later carried out, in order to achieve sufficient surface roughness and to generate undercuts for the mechanical cramping of the metal layer to the plastic surface. In place of the chemical etching, a plasma etching or a combination of both methods can be employed. By pretreating the surface, reaction-inhibiting oxide layers and impurities are also removed.

Following the pretreatment of the plastic surface, the roughened areas, for preparation for the electroplating, are activated, for example, by being dipped into a solution of colloidal palladium, rinsed, and, in an electroless process, provided with a conductive metal layer. For this purpose, the pretreated and activated plastic surface is dipped into a bath which contains both a metal salt as well as a reducing agent. By way of example, combinations of nickel salts with hypophosphite, or copper salts and an organic reducing agent such as formaldehyde are suitable. In this way, conductive metal layers are produced in a desired pattern with layer thicknesses of up to 10 μm. No metal deposition occurs on plastic surfaces that are not roughened or activated.

The conductive metal layers that are produced in this manner are then connected to a current as the cathode in a suitable electrolyte and are reinforced to the desired layer thickness by electroplating. In this way, different electrically conductive metals, such as nickel, copper, chromium, or silver, and combinations thereof can be applied. With good adhesive strength, the overall layer thickness can be up to 2 mm. The electrically conductive metal layers at this thickness increase the strength of the basic plastic component and at the same time can be used as electrical contact elements and leads.

1. An assembly comprising a steering wheel (10) and a gasbag module (16) connected to the steering wheel (10), the gasbag module (16) including a generator support (20) formed of plastic for attaching a gas generator (34), wherein the generator support (20) in a predetermined area is reinforced by a metal layer that is produced by electroplating to a layer thickness effektive to increase the strength of the generator support, the metal layer constituting at least one electrically conductive contact element (28).

2. The assembly of claim 1, wherein the metal layer forms a conducting track, and the electrical contact element (28) is a part of the conducting track.

3. The assembly of claim 1, wherein, for activating an electrical function element, the electrical contact element (28) cooperates with an opposite contact (30) on the steering wheel (10).

4. The assembly of claim 1, further comprising a plastic latching element (22) that is arranged on the generator support (20), the latching element (22) being reinforced by a further metal layer (32) that is formed by electroplating.

5. The assembly of claim 1, wherein the gasbag module (16) includes a gas generator (34) having a housing (38) made of plastic, and the plastic housing is reinforced by a further metal layer (40) that is formed by electroplating.

6. The assembly of claim 1, wherein the metal layer is between 100 μm and 2 mm thick.

7. The assembly of claim 1, wherein the plastic is a thermoplastic.

8. A method for manufacturing an assembly comprising a steering wheel (10) and a gasbag module (16) connected to the steering wheel (10), the gasbag module (16) including a generator support (20) formed of plastic for attaching a gas generator (34), the method comprising the steps of:
pretreating a surface of the generator support (20) made of plastic in a predetermined area for generating a surface roughness, and
electroplating the pretreated surface to form an adherently bonded, electrically conductive metal layer to a layer thickness effective for increasing a strength of the generator support.

9. The method of claim 8, wherein the pretreatment of the surface includes a chemical etching and/or plasma etching.

10. The method of claim 8, further comprising a step of electrolessly plating a metal onto said pretreated surface prior to said electroplating step.

11. The method of claim 8, wherein the metal layer forms at least one electrical contact element (28).

12. The method of claims 8, wherein the metal layer (32) is deposited on a latching element (22) that is arranged on the generator support (20).

13. The method of claim 8, wherein the metal layer is deposited in a layer thickness of between 100 μm and 2 mm.
